(19) United States
(12) Patent Application Publication
(10) Pub. No.: US 2024/0412414 A1
(43) Pub. Date: Dec. 12, 2024

(54) METHOD FOR DYNAMICALLY ESTIMATING THE PITCH AND THE ROLL OF A MOTOR VEHICLE BY MEANS OF AT LEAST ONE IMAGE CAPTURE SENSOR

(71) Applicant: Continental Autonomous Mobility Germany GmbH, Ingolstadt (DE)

(72) Inventors: Hugo CHOCHOY, Toulouse (FR); Gatien FERRET, Toulouse (FR); Matthieu BERGER, Toulouse (FR)

(73) Assignee: Continental Autonomous Mobility Germany GmbH, Ingolstadt (DE)

(21) Appl. No.: 18/702,374

(22) PCT Filed: Nov. 8, 2022
(86) PCT No.: PCT/EP2022/081053

§ 371 Date: Apr. 18, 2024

(30) Foreign Application Priority Data
Nov. 9, 2021 (FR) 2111847

(51) Int. Cl. G06T 7/80; G01C 1/00

(52) U.S. Cl. CPC G06T 7/80; G01C 1/00; G06T 2207/30244

(57) ABSTRACT

A method for dynamically estimating the pitch and roll of a motor vehicle by at least one image-acquiring sensor that is located on board the motor vehicle. The method includes at least one step of estimating an absolute extrinsic tilt angle of the sensor, using an equation that includes a drift-avoidance coefficient that depends partly on the acceleration experienced by the image-acquiring sensor in the course of the movement of the motor vehicle.

### CROSS REFERENCE TO RELATED APPLICATIONS

This application is the U.S. National Phase Application of PCT International Application No. PCT/EP2022/081053, filed Nov. 8, 2022, which claims priority to French Patent Application No. 2111847, filed Nov. 9, 2021, the contents of such applications being incorporated by reference herein.

### FIELD OF THE INVENTION

The present patent application relates to the field of advanced driver assistance systems employing an image-acquiring sensor of the video-camera type, and more particularly to optimization of acquisition of information relating to the environment of a motor vehicle using a method for dynamically estimating pitch and roll of a motor vehicle by means of at least one image-acquiring sensor that is mounted on the vehicle.

### BACKGROUND OF THE INVENTION

Advanced driver assistance systems (ADAS) are increasingly common in motor vehicles. They offer an increasing number of features with the aim of improving the comfort and safety of vehicle users. Ultimately, autonomous vehicles are conceivable.

Many of the functionalities offered by such systems rely on a real-time analysis of the immediate environment of the vehicle on board which they are located. Whether it is a question, for example, of assisting with emergency braking or improving control of the path of an automobile, it is necessary, at all times, for characteristics of the environment of the vehicle to be taken into account to provide the functionalities of the advanced driver assistance system.

In this context, one possible way of acquiring information relating to the immediate environment of a motor vehicle is to use means for acquiring and analyzing images. A vehicle may thus be equipped with one or more video cameras intended to observe its environment, at all times, in one or more observation directions. The images collected by the cameras are then processed by the advanced driver assistance system and the latter may use them to potentially trigger a driver assistance action, for example generation of an audio and/or visual alert, or even braking or changing of the path of the motor vehicle.

This type of operation assumes that the images collected by the one or more cameras allow the desired relevant information on the environment of the vehicle to be deduced reliably, and with the lowest possible computational cost. This in particular requires the acquired images to actually be representative of observed reality and not to contain any artefacts liable to distort perception of the environment by the advanced driver assistance system. This also requires, for certain functionalities, that it be possible for the advanced driver assistance system, on the basis of the images acquired by the camera, to correctly locate the various objects present in the three-dimensional space through which the vehicle is moving.

This is the case, for example, in the conventional situation where the advanced driver assistance system employs images acquired by a camera mounted on the front windscreen of a vehicle, near its central rear-view mirror. Specifically, for certain functionalities to be able to employ such images it is necessary to know the relationship between the spatial coordinates of a point in space and the corresponding point in the image acquired by the camera, which therefore presupposes knowledge of the spatial relationship between the camera and vehicle. To ensure satisfactory knowledge of these relationships, it is known to carry out calibration of the camera relatively frequently. The purpose of this calibration is to determine parameters, called intrinsic parameters and extrinsic parameters, of the camera.

The intrinsic parameters are related to the specific technical characteristics of the camera, such as, for example, its focal length, the position of its optical center or its distortion model. Their calibration allows these parameters to be estimated and this is therefore done in the factory at the end of the production line of the camera.

The extrinsic parameters correspond, for their part, to the position and orientation of the camera with respect to an assumed world frame, which is subject to potential tilt of the vehicle with respect to the road over which the vehicle is being driven, parallel to said road. These parameters comprise the three translations and three rotations required to pass from the coordinates of a point expressed in a frame defined above (called the “world frame”) to the coordinates of this point expressed in a frame linked to the camera (called the “camera frame”). Calibration of these parameters (six in total) then allows the position and orientation of the camera with respect to the road to be estimated. In addition, since these parameters change more frequently than the intrinsic parameters, for example in the event of a change in vehicle load, the extrinsic parameters may be calibrated relatively frequently in order to constantly adjust their values to the situation encountered.

The notion of “calibration” often applies to a variable that varies little and that defines an “absolute angle” between the camera and the world frame. It is an average, or a “nominal” value, that does not take into account oscillations of the camera. A distinction is made between the calibration at the end of the production line of the vehicle, which uses a production test pattern, and the so-called “on-line” calibration, which is based on the video stream delivered by the camera.

Finally, the objective of the calibration of the camera is to facilitate exploitation of the images acquired by the camera, in order to improve localization in space of the various observed objects.

Nonetheless, regardless of the frequency with which it is carried out, calibration does not allow dynamic pitch and roll, which cause substantial dynamic changes to the orientation of the camera, to be followed.

By pitch of the camera, what is meant is an angular movement of the camera about a transverse axis perpendicular to the longitudinal path of the motor vehicle, and by roll what is meant is an angular movement of the camera about a longitudinal axis parallel to the longitudinal path of the motor vehicle, their values being estimated using the video stream delivered by the camera.

The notion of dynamic pitch and roll regards the same physical quantity as the calibration, i.e. the angle of the camera with respect to a frame, generally the “world” frame.

However, dynamic pitch and roll are not averages or nominal values but instantaneous values that oscillate about the calibration values.

Typically, in situations such as crossing a humpback bridge, a substantial acceleration or deceleration, or a sudden change in slope, the value of the instantaneous pitch may temporarily deviate, significantly, from its calibrated value. Likewise, when the vehicle is driven over a speed cushion or pothole in an “asymmetrical” manner, or in other words when only the wheels on one side of the vehicle pass over the speed cushion or pothole, or in the case of a sharp bend, the instantaneous roll value may temporarily deviate, significantly, from its calibrated value.

However, whether the angle corresponding to pitch and the angle corresponding to roll are known satisfactorily has a decisive impact on localization in space of the objects observed by the camera of a motor vehicle. Therefore, poor evaluation thereof, albeit temporarily, is liable to affect correct determination of the position of the objects surrounding the vehicle, and therefore to limit or even block certain ADAS functionalities based thereon.

In order to estimate the instantaneous pitch, which will be referred to simply as pitch below, and the instantaneous roll, which will be referred to simply as roll below, of a camera located on board a vehicle dynamically, i.e. in order to gauge rapid variations related to occasional changes in driving environment, it is already known to use the SLAM method (SLAM standing for Simultaneous Localization And Mapping).

This method consists, firstly, in simultaneously constructing the map of a place and locating the vehicle therein. It may moreover allow the pitch and roll of the camera to be estimated, in particular by tracking, in the image, certain noteworthy objects and their movement from one image to another. However, it is very much subject to detection noise and is relatively limited in terms of the reactivity with which the pitch value and roll value can actually be updated, when it is a question of obtaining a robust estimation.

Moreover, another known method consists in processing the images acquired by the on-board camera of a vehicle in order to recognize therein, in each image, the position of the line markings of the road over which the vehicle is being driven, and, to deduce therefrom, in real time, one or more tilt angles of the camera. This method allows pitch to be estimated dynamically but presupposes that the vehicle to be being driven over a road having parallel and recognizable line markings.

In addition, in the case of the two aforementioned methods, the estimation of the pitch value and of the roll value is only satisfactory in cases where they remain sufficiently close to expected values. In other words, as soon as the amplitude of the variation in pitch becomes very great, as is for example the case when crossing a humpback bridge or when accelerating sharply, or as soon as the amplitude of the variation in roll becomes very great, as is for example the case when crossing a speed cushion or a pothole, the two aforementioned methods may not be able to follow the changes in camera angle.

In order to overcome the drawbacks of the two methods mentioned, a method for dynamically estimating the pitch and roll of a motor vehicle is known, this method being described and illustrated in document EP3579191B1, incorporated herein by reference.

The method described in document EP3579191B1 comprises a first step of computing an extrinsic tilt angle of a camera, which angle is estimated by integrating the relative movement of the camera at a current time t, and a second step of estimating an extrinsic tilt angle of the camera with drift correction.

By “tilt angle” or “angle of tilt” what is meant is a pitch angle but also a roll angle, i.e. the angle between the camera frame and the world frame.

The first computing step determines the tilt angle using the following equation:

θᵢₙₜ(t)=θ(t−1)−θᵣₑₗ(t) with θ(t−1) the absolute extrinsic tilt angle of the camera at a previous time t−1, and θᵣₑₗ(t) the relative tilt angle of the camera at the current time t, which expresses the angle of tilt of the sensor between said previous time t−1 and the current time t.

The second step estimates the tilt angle of the camera using the following equation:

θ(t)=θᵢₙₜ(t)+DAC(t)*(θ_{calib}(t)−θᵢₙₜ(t)) with θ(t) the absolute extrinsic tilt angle of the camera, at the current time t, θᵢₙₜ(t) the extrinsic tilt angle of the camera estimated by integrating the relative movement of the camera in the course of the preceding first computing step, at the current time t, DAC(t) a drift-avoidance coefficient comprised between zero and one, at the current time t, and θ_{calib}(t) the calibration extrinsic tilt angle at the current time t, which is known at all times and which corresponds to the nominal value of the tilt angle of the camera when the motor vehicle is not moving.

The drift-avoidance coefficient is also known as the DAC for short.

Advantageously, the method described in document EP3579191B1 takes into account the movement of the camera and the multiplicity of driving scenarios that may be encountered, while avoiding drift through use of the drift-avoidance coefficient.

However, the drift-avoidance coefficient depends only on the movement of the camera, so that when the inter-image movement is large, the drift-avoidance coefficient tends toward zero and the tilt angle estimate θ(t) approaches the extrinsic tilt angle of the camera estimated by integrating the relative movement of the camera θᵢₙₜ(t).

In contrast, when the inter-image movement is small, the drift-avoidance coefficient tends toward its maximum value and the estimate of the tilt angle θ(t) approaches its reference value θ_{calib}(t).

However, the motor vehicle may have a prolonged tilt under certain conditions.

For example, in the case of a motor vehicle of the truck type equipped with a suspended cab, the cab may remain tilted at a constant angle for several seconds, due to the inertial force being experienced by the cab.

Thus, in the case of emergency braking or in the case of a long bend, the cab of the motor vehicle and the camera mounted on the cab may maintain a pitch angle and a roll angle, respectively, for several seconds.

Therefore, under certain conditions, the method described in document EP3579191B1 does not allow roll and pitch angles to be estimated reliably, this potentially causing the tracked object to be lost or the distance to the tracked object to be misestimated.

### SUMMARY OF THE INVENTION

The aspect of the present invention aims to overcome the aforementioned drawbacks of the prior art.

This aspect as well as others that will become apparent on reading the following description are achieved with a method for dynamically estimating the pitch and roll of a motor vehicle by means of at least one image-acquiring sensor that is located on board said motor vehicle, which method comprises at least:
a first step of computing at least an extrinsic tilt angle of the sensor estimated by integrating the relative movement of the sensor θᵢₙₜ(t) at a current time t, using the following equation:

θᵢₙₜ(t)=θ(t−1)−θᵣₑₗ(t) with:
i. θ(t−1) the absolute extrinsic tilt angle of the sensor at a previous time t−1,
ii. θᵣₑₗ(t) the relative tilt angle of the sensor at the current time t, which expresses the angle of tilt of the sensor between said previous time t−1 and the current time t,
a second step of estimating at least an absolute extrinsic tilt angle of said sensor, using the following equation:

θ(t)=θᵢₙₜ(t)+DAC(t)*(θ_{calib}(t)−θᵢₙₜ(t)) with:
i. θ(t) the absolute extrinsic tilt angle of the sensor, at the current time t,
ii. θᵢₙₜ(t) the extrinsic tilt angle of the sensor estimated by integrating the relative movement of the sensor in the course of the preceding computing first step, at the current time t,
iii. DAC(t) a drift-avoidance coefficient, comprised between zero and one, at the current time t,
iv. θ_{calib}(t) the calibration extrinsic tilt angle at the current time t, which is known at all times and which corresponds to the nominal value of the tilt angle of the sensor when the motor vehicle is not moving,
characterized in that the drift-avoidance coefficient DAC(t) depends partly on the acceleration experienced by the image-acquiring sensor in the course of the movement of the motor vehicle.

According to other optional features of the method according to an aspect of the invention, taken individually or in combination:
the drift-avoidance coefficient DAC(t) depends partly on the movement of the sensor between the current time t and a previous time;
the estimating second step comprises computing the drift-avoidance coefficient DAC(t) using the following equation:

DAC(t)=min(DACᵣₑₗ(t),DAC_{\vec{a}}(t)) with:
DACᵣₑₗ(t) a relative drift-avoidance coefficient that depends on the movement of the sensor and that is obtained using the following equation:

$$D A {C}_{rel} ( t ) = D A {C}_{maxrel} * ( 1 - min ( {\int }_{t - Nrel}^{t} \frac{\vert {θ}_{rel} ( x ) \vert}{θ A M R} d x , 1 ) )$$

with DACₘₐₓᵣₑₗ a predetermined maximum value of the relative drift-avoidance coefficient DACᵣₑₗ(t), Nrel a predetermined number corresponding to the selected value of the number of previous times used to determine the relative drift-avoidance coefficient DACᵣₑₗ(t), θᵣₑₗ(t) the relative tilt angle of the sensor at the current time t, and θAMR a predetermined empirical maximum value of the relative tilt angle of the sensor at the current time θᵣₑₗ(t),
DAC_{\vec{a}}(t) an acceleration drift-avoidance coefficient that depends on the acceleration experienced by the sensor, and that is obtained using the following equation:

$$D A {C}_{\vec{a}} ( t ) = D A {C}_{ma x \vec{a}} * ( 1 - min ( {\int }_{t - Na}^{t} \frac{\vert \vec{a} ( x ) \vert}{\vec{a} A M R} dx , 1 ) )$$

with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the image-acquiring sensor at the time t, and \vec{a}AMR a predetermined empirical maximum value of the acceleration \vec{a}(t) of the image-acquiring sensor;
the absolute extrinsic tilt angle θ(t) of the sensor is a roll angle corresponding to an angular oscillatory movement of the sensor about a longitudinal axis that on the whole is parallel to the longitudinal path of the motor vehicle;
the acceleration \vec{a}(t) of the image-acquiring sensor is a transverse centrifugal acceleration in a direction that on the whole is perpendicular to the path of the motor vehicle;
the absolute extrinsic tilt angle θ(t) of the sensor is a pitch angle corresponding to an angular oscillatory movement of the sensor about a transverse axis that on the whole is perpendicular to the longitudinal path of the motor vehicle;
the acceleration \vec{a}(t) of the image-acquiring sensor is a longitudinal acceleration along the longitudinal path of the motor vehicle;
the motor vehicle is equipped with a driver's cab that is mounted so as to be able to oscillate rollwise and pitchwise with respect to the chassis of said vehicle and that bears the image-acquiring sensor.

An aspect of the present invention also relates to a device for dynamically estimating the pitch and roll of a motor vehicle by means of at least one image-acquiring sensor that is located on board said vehicle, said device being intended to implement the method described above, the device comprising at least one image-acquiring sensor that is mounted on said vehicle and a processing unit for determining the absolute extrinsic tilt angle θ(t) of the sensor.

### BRIEF DESCRIPTION OF THE DRAWINGS

Further features and advantages of aspects of the invention will become apparent on reading the following description, with reference to the appended figures, which illustrate:

FIG. 1: a schematic view of a motor vehicle equipped with a suspended cab and a video camera that does not have a dynamic tilt angle;

FIG. 2: a schematic view of the motor vehicle of FIG. 1 in a braking position in which the camera has a pitch angle;

FIG. 3: an example of variation in the orientation of the camera relative to the pitch angle;

FIG. 4: a schematic view of the motor vehicle of FIG. 1 in a banked position in which the camera has a roll angle at a time t−1;

FIG. 5: a schematic view similar to the one of FIG. 4 in which the camera has a roll angle at a current instant t;

FIG. 6: an example of variation in the orientation of the camera relative to the roll angle.

In the exhibits of the present patent application, non-limitingly and with reference to the system of axes L, V, T indicated in the figures, the terminology longitudinal, vertical and transverse will be employed, the motor vehicle being considered to extend longitudinally and to move forward longitudinally.

In all of these figures, identical or similar elements have been designated by identical or similar reference signs in all the figures.

### DETAILED DESCRIPTION OF THE PREFERRED EMBODIMENTS

FIG. 1 shows a motor vehicle 10 of the truck type, on board which is located an image-acquiring sensor that consists of a video camera 12.

The video camera 12 is mounted on the front windshield of a driver's cab 13, for example in the vicinity of the central rear-view mirror, so as to scrutinize the immediate environment of the motor vehicle 10, as illustrated in FIG. 1 by the field of view 14 of the video camera 12.

The driver's cab 13 is mounted so as to be able to roll and pitch with respect to the chassis of the vehicle, for example by means of a suspension device.

The digital images acquired by the video camera 12 are transmitted to a processing unit 16 belonging to an advanced driver assistance system, for example in order to allow the advanced driver assistance system to detect objects and to make a decision to actively intervene in driving the motor vehicle 10.

Also, the advanced driver assistance system comprises a device 18 for dynamically estimating the pitch and roll of the motor vehicle 10, which is configured to implement a method for dynamically estimating the pitch and roll of the motor vehicle 10 according to an aspect of the invention.

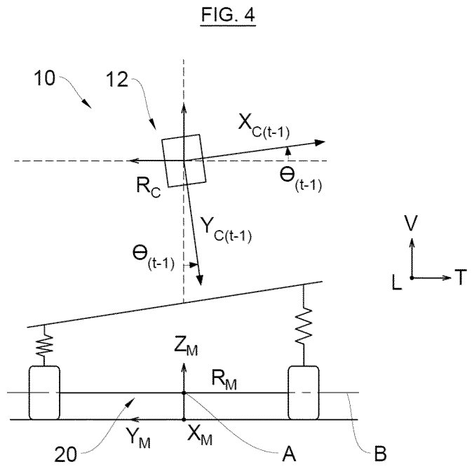

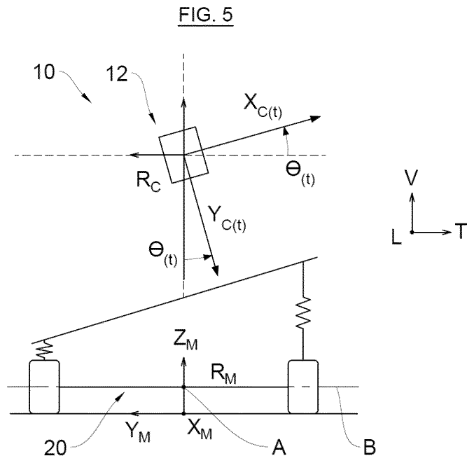

By roll what is meant is a dynamically estimated absolute extrinsic tilt angle θ(t) of the video camera 12 corresponding to a tilt angle of the video camera 12 about a longitudinal axis A that on the whole is parallel to the longitudinal path of the motor vehicle 10, as may be seen in FIGS. 4 and 5.

In other words, roll corresponds to a tilt of the structure of the motor vehicle 10, and therefore of the video camera 12, to the left or to the right with reference to the path of movement of the motor vehicle 10 when traveling forward.

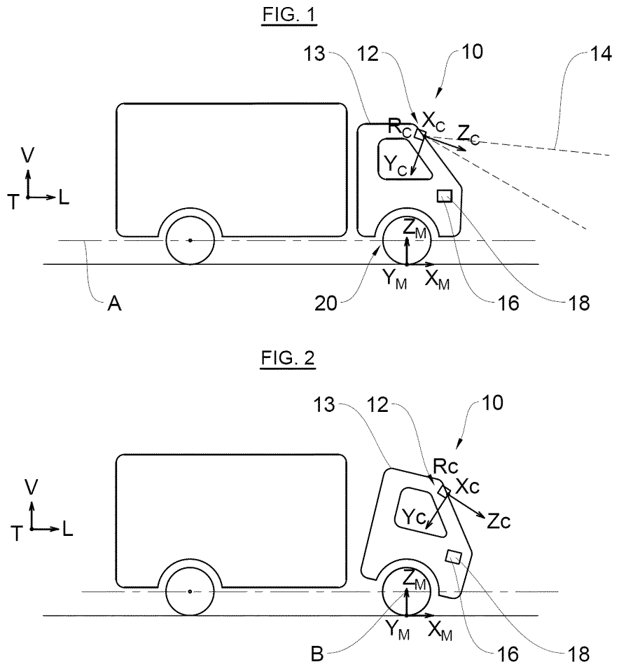

Also, by pitch what is meant is a dynamically estimated absolute extrinsic tilt angle θ(t) of the video camera 12 corresponding to a tilt angle of the video camera 12 about a transverse axis B that on the whole is perpendicular to the longitudinal path of the motor vehicle 10, as may be seen in FIG. 2.

In the remainder of the description, the absolute extrinsic tilt angle θ(t) will designate, mutatis mutandis, the pitch angle or roll angle of the video camera 12, in particular in the mathematical formulae described below.

FIGS. 1 to 5 show a first three-dimensional frame R_{C} {x_{C}, y_{C}, z_{C}} that is called the camera frame and that is linked to the video camera 12, and a second three-dimensional frame R_{M} {x_{M}, y_{M}, z_{M}} that is called the world frame.

The world frame R_{M} is linked to the front wheel set 20 of the motor vehicle 10 and is projected onto the road.

Generally, pitch and roll angles are angles of rotation between axes of the camera frame R_{C} and axes of the world frame R_{M}.

It will be noted that the orientation of the world frame R_{M} is related to the slope up or down which the motor vehicle 10 is moving. For example, if the vehicle is moving up or down a sufficiently long slope, the world frame will be aligned with this slope.

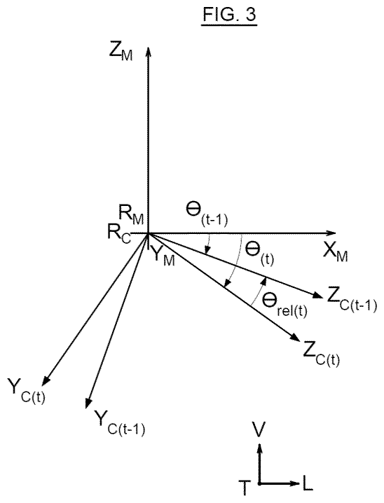

As may be seen more clearly in FIG. 3, the absolute extrinsic tilt angle θ(t) is an estimated pitch angle at a time t defined as being the angle made, at this time t, between the axis z_{C} of the camera frame R_{C} and the axis x_{M} of the world frame R_{M}.

Likewise, with reference to FIGS. 4 to 6, the absolute extrinsic tilt angle θ(t) is an estimated roll angle at a time t defined as being the angle made, at this time t, between the axis x_{C} of the camera frame R_{C} and the axis y_{M} of the world frame R_{M}.

Those skilled in the art will understand that the pitch and roll shown here, and estimation of an aspect of the invention, are the extrinsic pitch and roll, in the sense defined above with reference more generally to the extrinsic parameters of the video camera 12.

The potential variation in the intrinsic parameters, such as defined above, is not the object of the estimation described below. Specifically, these parameters are calibrated and, in general, are not subject to significant variations over short timescales. They may therefore be considered stable with regard to the dynamic phenomena that the estimating method according to an aspect of the invention aims to follow, which are related to events that happen while driving, over the roadway of a road, such as passing over a humpback bridge or over a speed bump, i.e. over an abrupt bump or dip, in the case of pitch, or indeed over a speed cushion, through a fast turn or over a pothole in the case of roll, respectively.

The method for dynamically estimating the pitch and roll of the motor vehicle 10 according to an aspect of the invention comprises a first step of computing an extrinsic tilt angle of the video camera 12, which angle is estimated by integrating the relative inter-image movement fᵢₙₜ(t) of the camera 12 at a current time t, using the following equation:

θᵢₙₜ(t)=θ(t−1)−θᵣₑₗ(t)

with θ(t−1) the absolute extrinsic tilt angle of the video camera 12 at a previous time t−1, and θᵣₑₗ(t) the relative tilt angle of the video camera 12 at the current time t, which expresses the angle of tilt of the video camera 12 between the previous time t−1 and the current time t.

By previous time, what is for example meant is the time of acquisition of the previous image by the video camera 12 in a sequence of successive acquisitions, or the time of acquisition of an image separated by a given number of acquisitions, which number is for example chosen in advance, in said sequence, or else the time of acquisition of a prior image acquired a certain time before the time t.

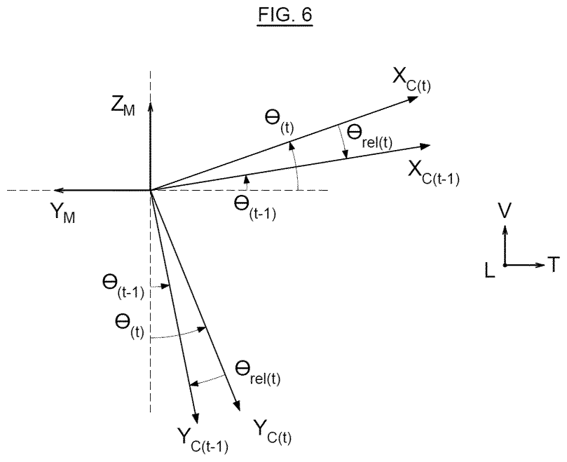

Examples of variation in the orientation of the video camera 12 are given in FIGS. 3 and 6.

The method according to an aspect of the invention comprises a second step of estimating an absolute extrinsic tilt angle of the video camera 12, which step is carried out after the first step, using the following equation:

θ(t)=θᵢₙₜ(t)+DAC(t)*(θ_{calib}(t)−θᵢₙₜ(t))

with θ(t) the absolute extrinsic tilt angle of the video camera 12, at the current time t, θᵢₙₜ(t) the extrinsic tilt angle of the video camera 12 estimated by integrating the relative inter-image movement of the camera in the course of the preceding first computing step, at the current time t, DAC(t) a drift-avoidance coefficient comprised between zero and one, at the current time t, and θ_{calib}(t) the calibration extrinsic tilt angle at the current time t, which is known at all times and which corresponds to the nominal value of the tilt angle of the video camera 12 when the vehicle 10 is not moving.

The value of the calibration extrinsic tilt angle θ_{calib}(t) as a function of time may be obtained using any known extrinsic calibration method, such as, for example, the SLAM method or tracking of white lines.

The calibration extrinsic tilt angle θ_{calib}(t) is a reference angle, it is also possible to use the angle of the video camera 12 as set during design of the vehicle, or the angle estimated during calibration at the end of the production line of the vehicle.

The drift-avoidance coefficient DAC(t) avoids, as its name suggests, drift in the estimation of the tilt angle θ(t).

Specifically, the estimated tilt angle θ(t) may drift from the true value through accumulation over time of errors in the estimation of the tilt angle estimated by integrating the relative movement of the camera 12 θᵢₙₜ(t).

In the absence of the drift-avoidance coefficient DAC(t), potential errors in estimating the relative tilt angle θᵣₑₗ(t) of the video camera 12 would be summed over time, which could result in errors in estimating the estimated tilt angle θ(t) and, in extreme cases, significant discrepancies between the estimated tilt angle θ(t) and the actual tilt angle.

Depending on the value attributed to the drift-avoidance coefficient DAC(t), computation of the tilt angle θ(t) is restricted to a greater or lesser extent by the calibration extrinsic tilt angle θ_{calib}(t).

In order for the estimation of the tilt angle θ(t) of the video camera 12 to be able to handle, without drifting, the multiplicity of driving scenarios that may be encountered, the drift-avoidance coefficient DAC(t) is computed, in the course of the estimating second step of the method, using the following equation:

DAC(t)=min(DACᵣₑₗ(t),DAC_{\vec{a}}(t))

with DACᵣₑₗ(t) a relative drift-avoidance coefficient that depends on the movement of the video camera 12 and that is obtained using the following equation:

$$D A {C}_{rel} = D A {C}_{ma xrel} * ( 1 - min ( {\int }_{t - Nrel}^{t} \frac{\vert {θ}_{r e l} ( x ) \vert}{θ A M R} dx , 1 ) )$$

with DACₘₐₓᵣₑₗ a predetermined maximum value of the drift-avoidance coefficient DACᵣₑₗ(t), Nrel a predetermined number corresponding to the selected value of the number of previous times used to determine the relative drift-avoidance coefficient DACᵣₑₗ(t), θᵣₑₗ(t) the relative tilt angle of the video camera 12 at the current time t, and AMR a predetermined empirical maximum value of the relative tilt angle of the video camera 12 at the current time t θᵣₑₗ(t).

The acceleration drift-avoidance coefficient DAC_{\vec{a}}(t) is a drift-avoidance coefficient that depends on the acceleration experienced by the video camera 12 and that is obtained using the following equation:

$$D A {C}_{\vec{a}} ( t ) = D A {C}_{ma x \vec{a}} * ( 1 - min ( {\int }_{t - Na}^{t} \frac{\vert \vec{a} ( x ) \vert}{\vec{a} A M R} dx , 1 ) )$$

with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the video camera 12 at the time t, and \vec{a}AMR a predetermined empirical maximum value of the acceleration \vec{a}(t) of the video camera 12.

It will be noted that the parameters DACₘₐₓᵣₑₗ, Nrel, θAMR, DAC_{max\vec{a}}. Na and \vec{a}AMR may be modified to adjust the behavior of the algorithm allowing the absolute extrinsic tilt angle θ(t) of the video camera 12 to be estimated.

Advantageously, the drift-avoidance coefficient DAC(t) depends both on the movement of the video camera 12 between the current time t and a previous time with the relative drift-avoidance coefficient DACᵣₑₗ(t), and also on the acceleration experienced by the video camera 12 in the course of movement of the motor vehicle 10 with the acceleration drift-avoidance coefficient DAC_{\vec{a}}(t).

Specifically, when the inter-image movement is large, during passage over a pothole or a speed cushion for example, the relative drift-avoidance coefficient DACᵣₑₗ(t) tends toward zero and the estimated tilt angle θ(t) of the videocamera 12 approaches the extrinsic tilt angle of the video camera 12 estimated by integrating the relative motion of the camera 12 θᵢₙₜ(t).

In contrast, when the inter-image movement is small, for example in the course of a long period of emergency braking or when crossing a roundabout, the relative drift-avoidance coefficient DACᵣₑₗ(t) tends toward the predetermined maximum value DACₘₐₓᵣₑₗ of the acceleration drift-avoidance coefficient DAC_{\vec{a}}(t) and the estimation of the tilt angle θ(t) approaches its reference value, which is the calibration extrinsic tilt angle θ_{calib}(t) in the example described here.

The acceleration drift-avoidance coefficient DAC_{\vec{a}}(t) does not depend on the movement of the video camera 12 but on the acceleration \vec{a}(t) experienced by the video camera 12.

It will be noted that the acceleration \vec{a}(t) of the video camera 12 is a transverse centrifugal acceleration in a direction that on the whole is perpendicular to the path of the motor vehicle 10 when the absolute extrinsic tilt angle θ(t) of the video camera 12 is a roll angle.

The centrifugal acceleration \vec{a}(t) experienced by the video camera 12, and therefore by the cab of the motor vehicle 10, may be estimated by means of a set of sensors provided for this purpose. In cases where the small-angle approximation applies, the centrifugal acceleration \vec{a}(t) is given by the following equation:

\vec{a}=(t)=ω(t)*v(t)

with ω the angular velocity of the cab, which is approximated by the angular velocity of the chassis of the motor vehicle 10, and v the velocity of the cab, which is approximated by the velocity of the chassis of the motor vehicle 10.

In contrast, the acceleration \vec{a}(t) of the video camera 12 is a longitudinal acceleration along the longitudinal path of the motor vehicle 10 when the absolute extrinsic tilt angle θ(t) of the video camera 12 is a pitch angle.

Making the acceleration drift-avoidance coefficient DAC_{\vec{a}}(t) depend on the acceleration \vec{a}(t) makes it possible to take into consideration scenarios in which the cab, or more generally the holder of the video camera 12, is tilted for a non-negligible time by an inertial force.

For example, if the motor vehicle 10 enters a roundabout at low speed, the acceleration \vec{a}(t)) remains low and the acceleration drift-avoidance coefficient DACₐ(t) takes a value which tends toward the predetermined maximum value DAC_{max\vec{a}} of the acceleration drift-avoidance coefficient, and the tilt angle θ(t) approaches the value of the calibration extrinsic tilt angle θ_{calib}(t).

In contrast, if the motor vehicle 10 enters a roundabout at speed, or if the motor vehicle 10 initiates emergency braking, the acceleration \vec{a}(t) is high and the acceleration drift-avoidance coefficient DAC_{\vec{a}}(t) takes a value that tends toward zero, and the tilt angle θ(t) will not undergo filtering causing it to tend toward the value of the calibration extrinsic tilt angle θ_{calib}(t).

Thus, the method according to an aspect of the invention makes it possible to estimate the absolute extrinsic tilt angle θ(t) of the video camera 12, whether it is a question of a roll angle or pitch angle, stably in phases of low acceleration and reactively in phases of high acceleration or deceleration such as encountered when passing over a humpback bridge, crossing a roundabout or traveling up or down a short inclined road segment.

Of course, an aspect of the invention is described in the above by way of example. It will be understood that those skilled in the art will be able to produce various variant embodiments of the invention without thereby departing from the scope of the invention.

For example, a different combination of the acceleration drift-avoidance coefficient DAC_{\vec{a}}(t) and of the relative drift-avoidance coefficient DACᵣₑₗ(t) may be envisioned.

Likewise, non-limitingly, the relative drift-avoidance coefficient DACᵣₑₗ(t), or the drift-avoidance coefficient DAC(t), may be set to a constant value comprised between zero and one.

1. A method of dynamically estimating the pitch and roll of a motor vehicle by at least one image-acquiring sensor that is located on board said motor vehicle, which method comprises at least:
a first step of computing at least an extrinsic tilt angle of the sensor estimated by integrating the relative movement of the sensor θᵢₙₜ(t) at a current time t, using the following equation:
θᵢₙₜ(t)=θ(t−1)−θᵣₑₗ(t) with:
i. θ(t−1) the absolute extrinsic tilt angle of the sensor (12) at a previous time t−1,
ii. θᵣₑₗ(t) the relative tilt angle of the sensor at the current time t, which expresses the angle of tilt of the sensor between said previous time t−1 and the current time t,
a second step of estimating at least an absolute extrinsic tilt angle of said sensor, using the following equation:
θ(t)=θᵢₙₜ(t)+DAC(t)*(θ_{calib}(t)−θᵢₙₜ(t)) with:
I. θ(t) the absolute extrinsic tilt angle of the sensor, at the current time t,
ii. θᵢₙₜ(t) the extrinsic tilt angle of the sensor estimated by integrating the relative movement of the sensor in the course of the preceding computing first step, at the current time t,
iii. DAC(t) a drift-avoidance coefficient, comprised between zero and one, at the current time t,
iv. θ_{calib}(t) the calibration extrinsic tilt angle at the current time t, which is known at all times and which corresponds to the nominal value of the tilt angle of the sensor when the motor vehicle is not moving,
wherein the drift-avoidance coefficient DAC(t) depends partly on the acceleration experienced by the image-acquiring sensor in the course of the movement of the motor vehicle.

2. The method as claimed in claim 1, wherein the drift-avoidance coefficient DAC(t) depends partly on the movement of the sensor between the current time t and a previous time.

3. The method as claimed in claim 1, wherein the estimating second step comprises computing the drift-avoidance coefficient DAC(t) using the following equation:
DAC(t)=min(DACᵣₑₗ(t),DAC_{\vec{a}}(t)) with:
DACᵣₑₗ(t) a relative drift-avoidance coefficient that depends on the movement of the sensor (12) and that is obtained using the following equation:
$$D A {C}_{rel} ( t ) = D A {C}_{ma xrel} * ( 1 - min ( {\int }_{t - Nrel}^{t} \frac{\vert {θ}_{r e l} ( x ) \vert}{θ A M R} dx , 1 ) )$$
with
DACₘₐₓᵣₑₗ a predetermined maximum value of the relative drift-avoidance coefficient DACᵣₑₗ(t), Nrel a predetermined number corresponding to the selected value of the number of previous times used to determine the relative drift-avoidance coefficient DACᵣₑₗ(t), θᵣₑₗ(t) the relative tilt angle of the sensor (12) at the current time t, and θAMR a predetermined empirical maximum value of the relative tilt angle of the sensor (12) at the current time t θᵣₑₗ(t),
DAC_{\vec{a}}(t) an acceleration drift-avoidance coefficient that depends on the acceleration experienced by the sensor (12), and that is obtained using the following equation:
$${DAC}_{\vec{a}} = D A {C}_{ma x \vec{a}} * ( 1 - min ( {\int }_{t - Na}^{t} \frac{\vert \vec{a} ( x ) \vert}{\vec{a} A M R} dx , 1 ) )$$
with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the image-acquiring sensor at the time t, and \vec{a}AMR a predetermined empirical maximum value of the acceleration \vec{a}(t) of the image-acquiring sensor.

4. The method as claimed in claim 1, wherein the absolute extrinsic tilt angle θ(t) of the sensor is a roll angle corresponding to an angular oscillatory movement of the sensor about a longitudinal axis that on the whole is parallel to the longitudinal path of the motor vehicle.

5. The method as claimed in claim 3, wherein the acceleration \vec{a}(t) of the image-acquiring sensor is a transverse centrifugal acceleration in a direction that on the whole is perpendicular to the path of the motor vehicle.

6. The method as claimed in claim 1, wherein the absolute extrinsic tilt angle θ(t) of the sensor is a pitch angle corresponding to an angular oscillatory movement of the sensor about a transverse axis that on the whole is perpendicular to the longitudinal path of the motor vehicle.

7. The method as claimed in claim 3, wherein the acceleration \vec{a}(t) of the image-acquiring sensor is a longitudinal acceleration along the longitudinal path of the motor vehicle.

8. The method as claimed in claim 1, wherein the motor vehicle is equipped with a driver's cab that is mounted so as to be able to oscillate rollwise and pitchwise with respect to the chassis of said vehicle and that bears the image-acquiring sensor.

9. A device for dynamically estimating the pitch and roll of a motor vehicle by at least one image-acquiring sensor that is located on board said vehicle, said device being intended to implement the method as claimed in claim 1, the device comprising at least one image-acquiring sensor that is mounted on said vehicle and a processing unit for determining the absolute extrinsic tilt angle θ(t) of the sensor.

10. The method as claimed in claim 4, wherein the acceleration \vec{a}(t) of the image-acquiring sensor is a transverse centrifugal acceleration in a direction that on the whole is perpendicular to the path of the motor vehicle.
